(19) United States
(12) Patent Application Publication
(10) Pub. No.: US 2025/0307618 A1
(43) Pub. Date: Oct. 2, 2025

(54) OPTIMIZATION OF TRANSFORMER ENCODERS

(71) Applicant: TEXAS INSTRUMENTS INCORPORATED, Dallas, TX (US)

(72) Inventors: Varun Tripathi, Gurgaon (IN); Saideepak Bejawada, Nalgonda (IN); Pramod Swami, Bangalore (IN); Deepak Poddar, Bangalore (IN)

(21) Appl. No.: 18/917,252

(22) Filed: Oct. 16, 2024

(30) Foreign Application Priority Data
Mar. 28, 2024 (IN) 202441025344
Mar. 28, 2024 (IN) 202441025711

(51) Int. Cl. G06N 3/0499

(52) U.S. Cl. CPC G06N 3/0499

(57) ABSTRACT

Various embodiments of the present disclosure relate to optimizing the execution of a transformer network, and in particular, to optimizing the execution of non-linear operations within the transformer network. In one example embodiment, a technique for executing a transformer network within the context of an encoder is provided. The technique first includes generating embedding data based on sensor data, and generating key data, query data, and value data based on the embedding data. Next the technique includes producing a first result by performing a first matrix multiplication operation with respect to the key data and transpose-read query data. Next, the technique includes performing a SoftMax operation on the first result to produce a second result, and transpose-writing the second result to memory. Finally, the technique includes producing a third result by performing a second matrix multiplication operation with respect to the value data and transpose-written second result.

### CROSS-REFERENCE TO RELATED APPLICATION

This application is related to, and claims the benefit of priority to, India Provisional Patent Application No. 202441025344, filed on Mar. 28, 2024, and entitled “Methods to Improve Latency of Transformer Networks via Optimal Layout Selection and Transpose Fusion”, and India Provisional Patent Application No. 202441025711, filed on Mar. 28, 2024, and entitled “Method to Accelerate Patch Embedding for Efficient Inference of Vision Transformers”, both of which are hereby incorporated by reference in their entirety.

### TECHNICAL FIELD

Aspects of the disclosure are related to the field of computing hardware and software and more particularly to the optimization of transformer networks.

### BACKGROUND

A transformer network is a type of deep learning model which utilizes a transformer encoder to perform various, e.g., computer-vision tasks, language processing tasks, audio processing tasks, and the like. For example, the transformer encoder may be configured to execute the fixed-point computations of a transformer network which is configured to perform object detection, image classification, image segmentation, or another computer-vision task of the like. Input to a transformer network includes sensor data, while the output is task-dependent. Meaning, if the transformer network is configured to perform image classification, then input to the transformer network will include image data and the output of the transformer network will include a classification of the input image.

Currently, transformer networks rely on various attention mechanisms to perform a designated task. For example, a transformer network may transform image data into key data, query data, and value data, then cause the transformer encoder to execute various attention-based operations on the key, query, and value data to perform the designated task. For example, the transformer encoder may be configured to execute matrix multiplication operations, SoftMax operations, and other fixed-point computations of the like.

Typically, transformer networks offload the fixed-point computations of the transformer encoder to an associated hardware accelerator in efforts to improve the efficiency of the system. For example, a transformer network may offload the matrix multiplication operations of the transformer encoder to the associated hardware accelerator. Problematically, some computations of the transformer encoder (e.g., SoftMax operations) are non-linear, and are inefficient to be performed by a hardware accelerator.

As such, most transformer networks include transpose operations to linearize the data in memory for the non-linear operations of the transformer encoder. However, the addition of these transpose operations negates the efficiency which is gained by the use of a hardware accelerator, and instead adds to the latency, processing load, and power consumption of the transformer network. As a result of these drawbacks, most systems opt to use convolutional neural networks (CNNs) for computer-vision related tasks.

### SUMMARY

Disclosed herein is technology, including systems, methods, and devices for improving the efficiency of transformer encoders within the context of transformer networks. A transformer encoder is a type of deep learning architecture which employs various attention mechanisms to perform a designated task. In various implementations, a technique for optimizing the execution of the non-linear operations of a transformer encoder is provided.

In one example embodiment, the technique first includes generating embedding data based on sensor data. For example, the sensor data may be representative of image data while the embedding data is representative of an embedded representation of the image data. Next, the technique includes generating key data, query data, and value data based on the embedding data. For example, the technique may include applying various attention weights to the embedding data to generate key data, query data, and value data.

Next, the technique includes producing a first result by performing a first matrix multiplication operation with respect to the key data and the query data. For example, the technique may include reading the key data from memory and writing the key data to a left matrix input of the first matrix multiplication operation, and transpose-reading the query data from memory and writing the transposed-read query data to a right matrix input of the first matrix multiplication operation.

After execution of the first matrix multiplication operation, the technique then includes performing a SoftMax operation on the first result to generate a second result. For example, the technique may include performing a height-wise SoftMax operation on the first result to produce the second result.

Finally, the technique includes transpose-writing the second result to memory and performing a second matrix multiplication operation with respect to the transpose-written second result and the value data. For example, the technique may include reading the transpose-written second result from memory and writing the transpose-written second result to a left matrix input of the second matrix multiplication operation, and reading the value data from memory and writing the value data to a right matrix input of the second matrix multiplication operation.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A and 1B illustrate an operational environment in an implementation.

FIG. 2 illustrates a method in an implementation.

FIGS. 3A-3C illustrate a system in an implementation.

FIG. 4 illustrates a hardware accelerator in an implementation.

FIGS. 5A-5C illustrate an operational scenario in an implementation.

FIG. 6 illustrates an attention mechanism in an implementation.

FIGS. 7A-7C illustrate another operational scenario in an implementation.

FIG. 8 illustrates a computing system suitable for implementing the various operational environments, architectures, processes, scenarios, and sequences discussed below with respect to the other Figures.

### DETAILED DESCRIPTION

Technology is disclosed herein for improving the efficiency of transformer encoders within the context of transformer networks. A transformer network is a type of deep learning network which is designed for various applications. For example, a transformer network may be configured to perform image segmentation, image classification, object detection, language processing or another deep learning task of the like.

Within the context of a transformer network, a transformer encoder is a type of deep learning architecture which utilizes an attention mechanism to perform a designated task. An attention mechanism describes a technique, commonly used in machine learning applications, for analyzing input data to identify relevant sections of input data and different dependencies between the various sections. For example, the transformer encoder may employ self-attention mechanisms, scaled dot-product attention mechanisms, multi-headed attention mechanisms, location-based attention mechanisms, or a combination thereof.

Input to an attention mechanism includes embedded data. Embedded data is representative of data which has been embedded into a format that may be supplied to a transformer encoder. For example, the embedded data may be representative of an input image which was divided into a number of patches and embedded into a number of image vectors (or image matrices) that each represent a different patch of the input image. Alternatively, the embedded data may be representative of image vectors which have been previously analyzed by an attention mechanism of the transformer network. In either case, the attention mechanism employed by the transformer encoder is configured to cause the transformer encoder to apply varying weight values to the embedded data to generate query data, key data, and value data for each input vector represented by the embedded data.

The query data is representative of a vector which describes the perspective of an input vector within the context of the embedded data. The key data is representative of a vector which describes the relationship between an input vector and the other vectors represented by the embedded data. The value data is representative of a vector which describes the actual data of an input vector. During operation, the transformer encoder may execute various attention-based operations on the query data, key data, and value data of each input vector to perform the designated task. For example, such attention-based operations may include matrix multiplication operations, SoftMax operations, normalization operations, and other fixed-point computations of the like.

Existing techniques for executing the fixed-point computations of a transformer encoder rely on a hardware accelerator. For example, the transformer encoder may generate the query, key, and value data, and supply the generated data to a hardware accelerator configured to perform the various fixed-point computations of the transformer encoder. Problematically, some of the fixed-point computations are representative of non-linear operations and are inefficient to be executed by a hardware accelerator. Currently, transformer encoders utilize transpose operations to resolve the inefficiencies of the hardware accelerator. Consequently, the addition of the transpose operations negates the efficiency which is gained by the use of a hardware accelerator. In contrast, disclosed herein is a new technique for performing the fixed-point computations of a transformer encoder which is based on the architecture of an associated hardware accelerator, and by design, improves the efficiency of transformer networks.

In one example embodiment a computer-readable medium having executable instructions related to the optimization of attention mechanisms within transformer networks is provided. The instructions are configured to be executed by processing circuitry, such that when executed, the instructions cause the processing circuitry to efficiently execute the various attention-based operations of the transformer network, and more specifically, the various fixed-point computations of the transformer encoder.

In an implementation, the program instructions first cause the processing circuitry to receive key data, query data, and value data from a previous layer of the transformer network. For example, a previous layer of the transformer network may be configured to receive an input image, divide the input image into a number of patches, embed those patches into a number of image matrices, and apply various attention weights to each of the image matrices to generate key data, query data, and value data for each image matrix of the input image. Alternatively, the previous layer of the transformer network may be configured to apply the various attention weights to a number of intermediate patches, such that the number of intermediate patches represent image matrices which have been previously analyzed by an attention mechanism of the transformer network. For the purposes of explanation, a singular image matrix will be discussed herein. This is not meant to limit the applications of the proposed technology, but rather to provide an example.

Next, the program instructions cause the processing circuitry to perform a first matrix multiplication operation using the key data and the query data of a first image matrix. In an implementation, to perform the first matrix multiplication operation, the processing circuitry causes an associated hardware accelerator to execute the first matrix multiplication operation. For example, the processing circuitry may instruct the hardware accelerator to read in the key data of the first image matrix from memory and write the key data to a left matrix input of the first matrix multiplication operation. The processing circuitry may further instruct the hardware accelerator to read in the query data of the first image matrix from memory and write the query data to a right matrix input of the first matrix multiplication operation.

In an implementation, to read in the query data from memory, the hardware accelerator is configured to transpose-read the query data from memory and write the transpose-read query data to the right matrix input of the first matrix multiplication operation. Once written, the hardware accelerator is configured to perform the first matrix multiplication operation with respect to the left matrix input (storing the key data) and the right matrix input (storing the transpose-read query data) and output a first result of the first matrix multiplication operation. The first result is representative of a matrix which stores the attention scores for the first image matrix. The attention scores of the first image matrix represent data which assigns a relevance to the first image matrix in comparison to the other image matrices of the input image.

Next, the program instructions cause the processing circuitry to perform a SoftMax operation on the first result. A SoftMax operation is representative of a fixed-point computation for normalizing the attention scores of the first result. More specifically, the SoftMax operation is representative of a formula for determining a probability distribution for the first result. In an implementation, to perform the SoftMax operation, the processing circuitry causes the associated hardware accelerator to execute the SoftMax operation with respect to the first result. For example, the processing circuitry may instruct the hardware accelerator to perform a height-wise SoftMax operation on the first result to generate a second result. The second result is representative of a matrix which stores the attention weights for the first image matrix. The attention weights of the first image matrix represent normalized attention scores which may be used to evaluate the relevance of the value data of the first image matrix.

In an implementation, after generating the second result, the hardware accelerator is configured to transpose-write the second result to memory. Once written, the program instructions cause the processing circuitry to perform a second matrix multiplication operation using the value data of the first image matrix and the transpose-written second result. In an implementation, to perform the second matrix multiplication operation, the processing circuitry causes the associated hardware accelerator to execute the second matrix multiplication operation. For example, the processing circuitry may instruct the hardware accelerator to read in the transpose-written second result from memory and write the transpose-written second result to a left matrix input of the second matrix multiplication operation. The processing circuitry may further instruct the hardware accelerator to read in the value data of the first image matrix from memory and write the value data to a right matrix input of the first matrix multiplication operation.

Once written, the hardware accelerator is configured to perform the second matrix multiplication operation with respect to the left matrix input (storing the transpose-written second result) and the right matrix input (storing the value data) and output a third result of the second matrix multiplication operation. The third result is representative of a matrix which stores the final attention scores for the first image matrix.

In an implementation, the program instructions cause the processing circuitry to sum the final attention scores of each image matrix to generate a final result. The final result may be representative of a matrix which stores the final attention scores for the original input image. Alternatively, the final result may be representative of a matrix which stores the final attention scores for the number of intermediate patches. In an implementation, the final result is supplied to a network configured to form an output of the transformer network. For example, if the transformer network is configured to perform image classification, then the final result may be supplied to a multi-layer perceptron (MLP) network configured to classify the input image based on the provided attention scores. In an alternative implementation, the final result is supplied to a next layer of the transformer network. For example, the final result may be supplied to a layer configured to execute an attention mechanism.

Advantageously, the proposed technology optimizes the execution of the fixed-point computations of a transformer encoder, thereby reducing the latency, processing load, and power consumption of the transformer network, as compared to other approaches. As a result, the proposed technology is more efficient than applications which utilize transpose operations for linearizing data in memory. The proposed technology achieves this efficiency in part by removing some or all of the transpose operations that may be necessary for other approaches. The proposed transformer network may have fewer operations per layer (e.g., reduced processing load and reduced power consumption), as compared to other approaches. Thus, each layer of the proposed transformer network may complete in fewer clock cycles (i.e., have lower latency). Furthermore, the proposed technology provides an alternate solution for applications which utilize convolutional neural networks (CNNs) for computer-vision related tasks.

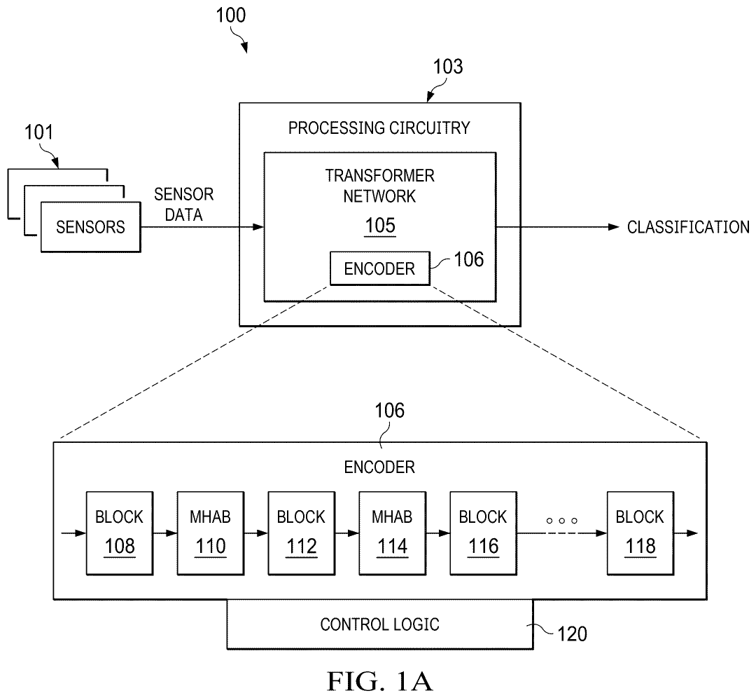

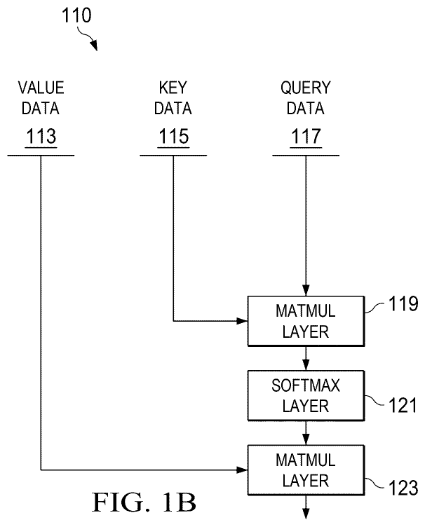

Now turning to the figures, FIG. 1A illustrates operating environment 100 in an implementation. Operating environment 100 is representative of an example environment configurable to execute a transformer network. For example, operating environment 100 may be representative of a system configured to perform a computer-vision task such as image classification, object detection, or another task of the like. Operating environment 100 may be implemented in a variety of use-cases such as automotive, industrial, robotics, building automation, language processing, power electronics, autonomous systems, radar, image processing, audio processing, or another application of the like which requires computer-vision and/or processing of other data (e.g., text data, language data, audio signals, radar signals, etc.). Operating environment 100 includes, but is not limited to, sensors 101 and processing circuitry 103.

Sensors 101 are representative of sensors configured to collect input data for executing a transformer network. For example, sensors 101 may be representative of cameras, radar devices, or another sensor of the like configured to collect sensor data for executing transformer network 105. In an implementation, sensors 101 are configured to collect image data or other sensor data of an environment. For example, sensors 101 may be representative of cameras which are mounted on a car and configured to collect image data of the car's surrounding environment. For the purposes of explanation, image data will be discussed herein. This is not meant to limit the applications of the proposed technology, but rather to provide an example. Sensors 101 are coupled to processing circuitry 103 and configured to output image data to processing circuitry 103.

Processing circuitry 103 is representative of circuitry configured to execute a transformer network. For example, processing circuitry 103 may be representative of a central processing unit (CPU), application-specific integrated circuit (ASIC), digital signal processor (DSP), microcontroller unit (MCU), graphics processing unit (GPU), tensor processing unit (TPU), or another general-purpose processor (GPP) of the like. Processing circuitry 103 includes, but is not limited to, transformer network 105.

Transformer network 105 is representative of a deep learning network configured to perform a designated task. Input to transformer network 105 includes sensor data, while the output of transformer network 105 is task dependent. For example, if transformer network 105 is configured to perform image classification, then sensors 101 may collect image data of an environment and provide the image data to transformer network 105. In response, transformer network 105 may output a classification for the image data. Transformer network 105 includes encoder 106.

Encoder 106 is representative of a transformer encoder which is configured to employ attention mechanisms for executing the task which transformer network 105 is configured to perform. An attention mechanism describes a technique for determining the relative importance of features captured by the image data of sensors 101. In an implementation, encoder 106 utilizes multi-headed attention mechanisms to execute transformer network 105. A multi-headed attention mechanism is representative of a type of attention mechanism which causes a transformer encoder to analyze different features of the input data simultaneously. Encoder 106 includes, but is not limited to, block 108, multi-headed attention block (MHAB) 110, block 112, MHAB 114, block 116, block 118 and control logic 120.

Block 108 is representative of a processing block which is configured to generate input data for executing a multi-headed attention mechanism of encoder 106. For example, block 108 may be configured to generate the input data for executing MHAB 110. In an implementation, to generate the input data for executing MHAB 110, block 108 is configured to embed the image data of sensors 101 into a number of image matrices. For example, block 108 may receive image data from sensors 101, divide the image data into a number of image patches, embed those image patches into an equal number of image matrices, and supply the number of image matrices as input to MHAB 110. In response, MHAB 110 is configured to apply weight values to the number of image matrices to generate input data for executing the multi-headed attention mechanism of MHAB 110. For example, MHAB 110 may apply key weights, query weights, and value weights to each image matrix to generate key data, query data, and value data for each of the image matrices.

The query data of an image matrix is representative of a matrix which describes the perspective of the image matrix within the input image. For example, the query data may signify that the image matrix represents the first image matrix of the input image. The key data of an image matrix is representative of a matrix which describes the relationship between the image matrix and other image matrices within the input image. For example, the key data may signify that the image matrix comprises data which correlates to the data of other image matrices of the input image. The value data of an image matrix is representative of a matrix which describes the actual data of the image matrix. For example, the value data may store the data of the image matrix.

MHAB 110 is representative of a processing block which is configured to execute a series of attention-based operations on the query data, key data, and value data of each image matrix. For example, MHAB 110 may be configured to calculate the scaled dot-product attention for each image matrix of the input image. The scaled dot-product attention is representative of an attention mechanism for determining the normalized attention scores of an image matrix. In an implementation, to determine the scaled dot-product attention of each image matrix, MHAB 110 executes a series of layers, such that the first layer is representative of a matrix multiplication layer, the second layer is representative of a SoftMax layer, and the third layer is representative of another matrix multiplication layer, later discussed in detail with reference to FIG. 1B.

Output of MHAB 110 includes a final attention scores matrix. The final attention scores matrix is representative of a matrix which stores the final attention scores for each image matrix of the original input image. For example, if the input image was divided into four image matrices, then the output of MHAB 110 represents a matrix which stores the final attention scores of the four image matrices. In an implementation, MHAB 110 is configured to provide its output to block 112.

Block 112 is representative of processing block which is configured to generate input data for executing another multi-headed attention mechanism of encoder 106. For example, block 112 may be configured to generate the input data for executing MHAB 114. In an implementation, to generate the input data for executing MHAB 114, block 112 is configured to normalize the output of MHAB 110 and supply the normalized output to MHAB 114. For example, block 112 may comprise a normalization layer configured to normalize the final attention scores matrix of MHAB 110 and supply the normalized matrix to MHAB 114. In response, MHAB 114 is configured to apply weight values to the normalized matrix to generate input data for executing the multi-headed attention mechanism of MHAB 114. For example, MHAB 114 may apply key weights, query weights, and value weights to the normalized matrix to generate key data, query data, and value data for the normalized matrix.

MHAB 114 is representative of a processing block which is configured to execute a series of attention-based operations on the query data, key data, and value data of the normalized attention matrix. For example, MHAB 114 may also comprise multiple layers for computing the scaled dot-product attention, such that the first layer represents a matrix multiplication layer, the second layer represents a SoftMax layer, and the third layer represents another matrix multiplication layer. Output of MHAB 114 includes a final attention scores matrix. The final attention scores matrix of MHAB 114 is representative of a matrix which stores the final attention scores for the output of block 112. In an implementation, MHAB 114 is configured to provide its output to block 116.

Block 116 is representative of another processing block which is configured to generate input data for executing another multi-headed attention mechanism of encoder 106. For example, block 116 may be representative of block 112. In an implementation, block 116 is configured to normalize the output of MHAB 114 and supply the normalized output to the next layer of encoder 106. For example, block 116 may comprise a normalization layer configured to normalize the final attention scores matrix of MHAB 114 and supply the normalized matrix to a next MHAB of encoder 106. It should be noted that encoder 106 may comprise more than two MHABs, but for the purposes of explanation, only two were illustrated herein.

Block 118 is representative of a processing block which is configured to form the output of encoder 106. For example, block 118 may receive a final attention scores matrix from a previous MHAB of the network and normalize the final attention scores matrix of the MHAB to generate the output of encoder 106. In an implementation, the output of encoder 106 is supplied to a next layer of transformer network 105 which is configured to form an output for transformer network 105. For example, if transformer network 105 is configured to perform image classification, then block 118 may supply its output to a multi-layer perceptron (MLP) network configured to classify the input image. Alternatively, if transformer network 105 is configured to perform object detection, then block 118 may supply its output to an object detection network configured to output a warning for when an object is detected.

Control logic 120 is representative of software, executed by processing circuitry 103 for managing the execution of encoder 106. For example, processing circuitry 103 may execute control logic 120 to cause encoder 106 to execute the multi-headed attention mechanisms for performing the task of transformer network 105.

FIG. 1B illustrates the layers of MHAB 110 in an implementation. The layers of MHAB 110 are representative of processing layers which are configured to determine the scaled dot-product attention of an image matrix through a series of fixed-point computations. In an implementation, MHAB 110 is configured to offload the fixed-point computations of its processing layers to an associated hardware accelerator. For example, processing circuitry 103 may be coupled to a hardware accelerator configured to execute the various fixed-point computations of operating environment 100. MHAB 110 includes, but is not limited to, matrix multiplication layer 119, SoftMax layer 121, and matrix multiplication layer 123. It should be noted that, FIG. 1B further illustrates the layers of MHAB 114, but for the purposes of explanation, only the layers of MHAB 110 will be discussed herein.

Matrix multiplication layer 119 represents the first processing layer of MHAB 110. Input to matrix multiplication layer 119 includes the key data 115 and query data 117 of an associated image matrix, while the output includes a first result matrix. The first result matrix is representative of a matrix which stores the attention scores of the associated image matrix. The attention scores are representative of data which assigns a relevance to the associated image matrix in comparison to the other image matrices of the input image.

In an implementation, to perform the matrix multiplication operation of matrix multiplication layer 119, processing circuitry 103 is configured to instruct an associated hardware accelerator to execute the operation. For example, processing circuitry 103 may instruct the hardware accelerator to perform a matrix multiplication operation with respect to the key data 115 and query data 117 of an associated image matrix. In response, the hardware accelerator is configured to read in the key data 115 from memory and write the key data 115 to a left matrix input of the matrix multiplication operation, and transpose-read in the query data 117 from memory and write the transpose-read query data to a right matrix input of the matrix multiplication operation. Once written, the hardware accelerator is configured to produce the first result matrix by matrix multiplying the left matrix input with the right matrix input.

In an implementation, matrix multiplication layer 119 is configured to perform the matrix multiplication operation for each image matrix of an input image. For example, if an input image is embedded into four image matrices, then matrix multiplication layer 119 is configured to cause the hardware accelerator to generate four first result matrices, such that each first result matrix corresponds to one of the four image matrices of the input image. In another implementation, matrix multiplication layer 119 is configured to perform the matrix multiplication operation for each input matrix that was supplied to matrix multiplication layer 119. For example, if matrix multiplication layer 119 is supplied with six input matrices from a previous layer of encoder 106 (e.g., MHAB), then matrix multiplication layer 119 is configured to cause the hardware accelerator to generate six corresponding result matrices. Once generated, matrix multiplication layer 109 is configured to supply its output to SoftMax layer 121.

SoftMax layer 121 represents the second processing layer of MHAB 110. Input to SoftMax layer 121 includes a first result matrix, while the output includes a result of the SoftMax operation. A SoftMax operation is representative of a fixed-point computation for normalizing the attention scores produced by matrix multiplication layer 119. Meaning, the output of the SoftMax operation is representative of a second result matrix which stores the normalized attention scores of the first image matrix. It should be noted that some transformer networks employ operations other than SoftMax to normalize the attention scores of the first matrix multiplication operation. Such examples may be found in the following publications, “SimA: Simple SoftMax-free Attention for Vision Transformers” written by Soroush Koohpayegani et al., “SofterMax: Hardware/Software Co-Design of an Efficient SoftMax for Transformers” written by Jacob Stevens et al., and “Replacing SoftMax with ReLU in Vision Transformers” written by Mitchell Wortsman et al., which are hereby incorporated by reference in their entirety.

In an implementation, to perform the SoftMax operation of SoftMax layer 121, processing circuitry 103 is configured to instruct an associated hardware accelerator to execute the fixed-point computations of the SoftMax operation. For example, processing circuitry 103 may instruct the hardware accelerator to execute a height-wise SoftMax operation with respect to the first result matrix of an associated image matrix. In response, the hardware accelerator may generate a second result matrix for the associated image matrix. In an implementation, after generating the second result matrix, the hardware accelerator is configured to transpose-write the second result matrix to memory. For example, after executing the SoftMax operation of SoftMax layer 121, the hardware accelerator may transpose-write the result of the SoftMax operation to an associated memory.

In an implementation, SoftMax layer 121 is configured to perform the SoftMax operation for each output of matrix multiplication layer 119. For example, if matrix multiplication layer 119 outputs four first result matrices, then SoftMax layer 121 is configured to cause the hardware accelerator to generate four second result matrices. Once generated, SoftMax layer 121 is configured to supply its output to matrix multiplication layer 123.

Matrix multiplication layer 123 represents the third processing layer of MHAB 110. Input to matrix multiplication layer 123 includes the transpose-written second result matrix and the value data 113 of an associated image matrix, while the output includes a third result matrix. The third result matrix is representative of a matrix which stores the final attention scores of an associated image matrix.

In an implementation, to perform the matrix multiplication operation of matrix multiplication layer 123, processing circuitry 103 is configured to instruct an associated hardware accelerator to execute the operation. For example, processing circuitry 103 may instruct the hardware accelerator to perform a matrix multiplication operation with respect to the transpose-written second result matrix and the value data 113 of an associated image matrix. In response, the hardware accelerator is configured to read in the transpose-written second result matrix from memory and write the transpose-written second result matrix to a left matrix input of the matrix multiplication operation and, read in the value data 113 from memory and write the value data 113 to a right matrix input of the matrix multiplication operation. Once written, the hardware accelerator is configured to produce the third result matrix by matrix multiplying the left matrix input with the right matrix input.

In an implementation, matrix multiplication layer 123 is configured to perform the matrix multiplication operation on each output of SoftMax layer 121. For example, if SoftMax layer 121 outputs four second result matrices, then matrix multiplication layer 123 is configured to cause the hardware accelerator to generate four third result matrices. Once generated, matrix multiplication layer 123 is configured to supply its output to a next layer of transformer network 105. For example, matrix multiplication layer 123 may supply the third result matrices to a layer configured to generate a fourth result matrix by summing together the data of the third result matrices.

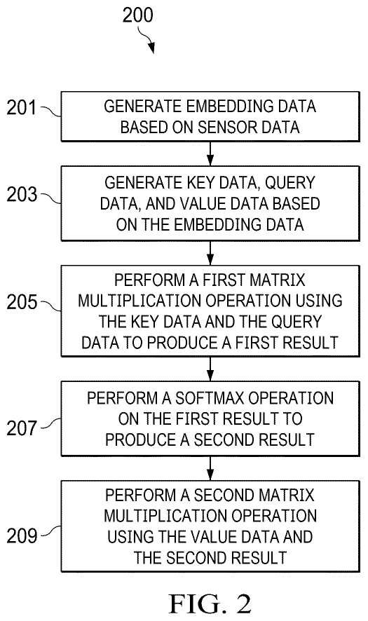

FIG. 2 illustrates method 200 in an implementation. Method 200 is representative of software for executing a transformer network. Method 200 may be implemented in the context of program instructions that, when executed by a suitable computing system, direct the processing circuitry of the computing system to operate as follows, referring parenthetically to the steps in FIG. 2. For the purposes of explanation, method 200 will be explained with the elements of FIGS. 1A and 1B. This is not meant to limit the applications of scheduling method 200, but rather to provide an example.

To begin, block 108 generates embedding data based on the sensor data collected by sensors 101 (step 201). For example, block 108 may receive image data from sensors 101, divide the image data into a number of patches, embed those patches into an equal number of image matrices, and supply the image matrices as input to MHAB 110. In response, MHAB 110 generates key data 115, query data 117, and value data 113 for each of the input matrices (step 203). For example, MHAB 110 may apply key weights, query weights, and value weights to each of the embedded patches to generate key data 115, query data 117, and value data 113 for each embedded patch.

Next, MHAB 110 is configured to execute matrix multiplication layer 119 (step 205). In an implementation, matrix multiplication layer 119 is executed by an associated hardware accelerator. For example, the hardware accelerator may be configured to read in key data 115 of a first embedded patch from memory and write the key data 115 to a left matrix input of the matrix multiplication operation. The hardware accelerator may be further configured to transpose-read query data 117 of the first embedded patch from memory and write the transpose-read query data 117 to a right matrix input of the matrix multiplication operation. Finally, the hardware accelerator may be configured to produce a first result by performing the matrix multiplication operation with respect to the left matrix input and the right matrix input.

The first result is representative of a matrix which stores the attention scores for the corresponding embedded patch. In an implementation, the hardware accelerator is configured to generate a first result for each embedded patch received by MHAB 110. For example, if MHAB 110 received six different embedded patches, then the hardware accelerator is configured to generate a first result matrix for each of the six embedded patches.

Next, matrix multiplication layer 119 outputs the first results to memory, and in response, MHAB 110 is configured to execute SoftMax layer 121 (step 207). In an implementation, SoftMax layer 121 is executed by an associated hardware accelerator. For example, the associated hardware accelerator may be configured to read in the first results from memory and execute a height-wise SoftMax operation on each of the first results to generate a set of second results. The set of second results are representative of matrices which store normalized attention scores for each of the first results, and more specifically, for each embedded patch.

In an implementation, the associated hardware accelerator is configured to transpose-write the second results to memory. For example, if the output of the SoftMax layer includes six different second results, then the hardware accelerator is configured to transpose-write each of the six different second results to memory. Once stored by the memory, MHAB 110 is triggered to execute matrix multiplication layer 123 (step 209).

In an implementation, matrix multiplication layer 123 is executed by an associated hardware accelerator. For example, the hardware accelerator may be configured to read in the transpose-written second result of an embedded patch from memory and write the transpose-written second result to a left matrix input of the matrix multiplication operation. The hardware accelerator may be further configured to read in the value data 113 of the first embedded patch from memory and write the value data 113 to a right matrix input of the matrix multiplication operation. Finally, the hardware accelerator is configured to produce a third result by performing the matrix multiplication operation with respect to the left matrix input and the right matrix input.

The third result is representative of a matrix which stores the final attention scores for the corresponding embedded patch. In an implementation, the hardware accelerator is configured to generate a third result for each of the embedded patches. For example, if MHAB 110 received six different embedded patches, then the hardware accelerator is configured to generate a third result matrix for each of the six embedded patches.

Once generated, matrix multiplication layer 123 is configured to supply the generated third results to a next layer of transformer network 105. For example, matrix multiplication layer 123 may supply the third results to a layer configured to sum the data of the third results to generate a fourth result. The fourth result is representative of a matrix which stores the final attention scores of each of the embedded patches. In an implementation, the fourth result is supplied to block 112.

Advantageously, method 200 takes advantage of the transpose-read and transpose-write capabilities of the hardware accelerator, thereby improving the efficiency of the transformer network. Furthermore, method 200 supplies the key data 115 as a left matrix input to the first matrix multiplication operation and supplies the transpose-read query data as a right matrix input to the first matrix multiplication operation thusly allowing the hardware accelerator to perform a height-wise SoftMax operation, rather than a width-wise SoftMax operation. As a result, method 200 provides a technique for efficiently executing the layers of a transformer encoder, which thereby optimizes the execution of the transformer network.

A height-wise SoftMax operation can be more efficient than a width-wise SoftMax operation. SoftMax is an operation which can see input data of [h×K×K] (in this example 3×197×197) as a series of independent h×K vectors and each of length K. Each of these vectors has to perform SoftMax and produce same length of vector as output. Softmax involves finding a maximum within the vector for numerical stabilization and hence includes intra-vector operations which are not very suitable for single instruction, multiple data (SIMD) architectures. A height-wise SoftMax operation involves performing a SoftMax on set of vectors instead of on single vector at a time. This can be maintained without any overhead from the producer of this data. SoftMax has multiple intermediate steps, and SoftMax can allow the final output to be in original layout (h×K×K) output without any additional cost. SoftMax can happen on a series of vectors preventing need of intra-vector operations. SoftMax can happen on h×K vectors allowing large number of vectors and allowing better utilization of architectures with larger SIMD width.

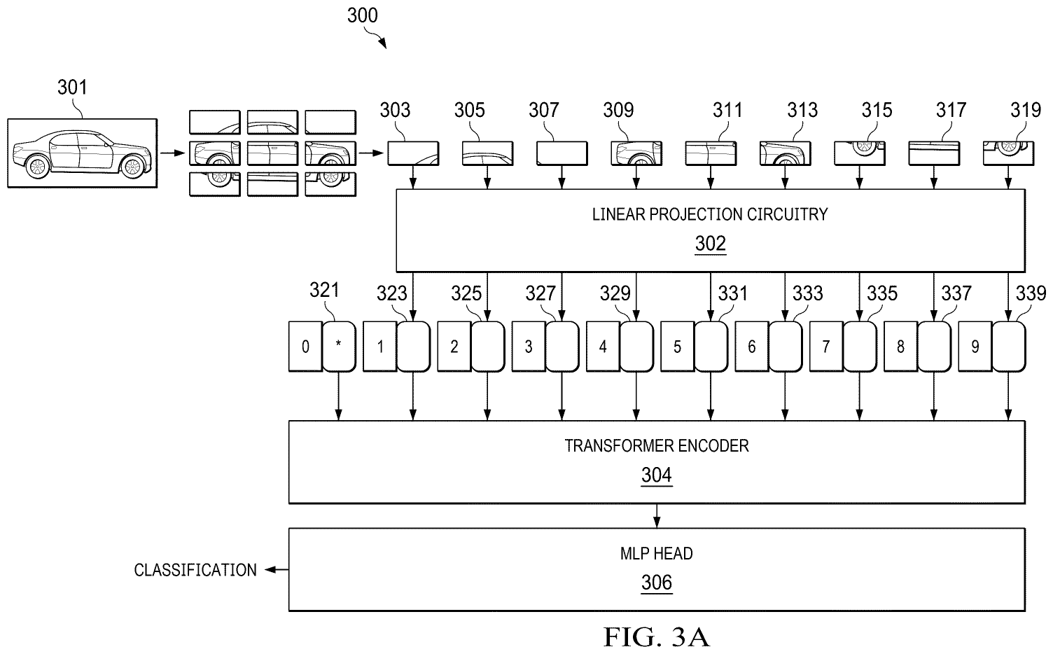

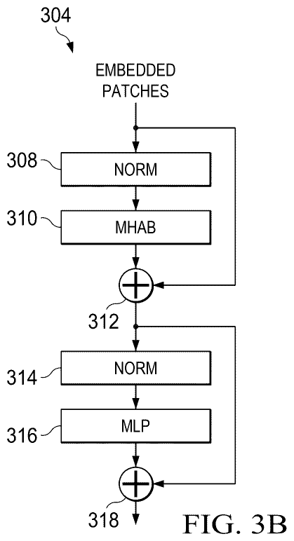

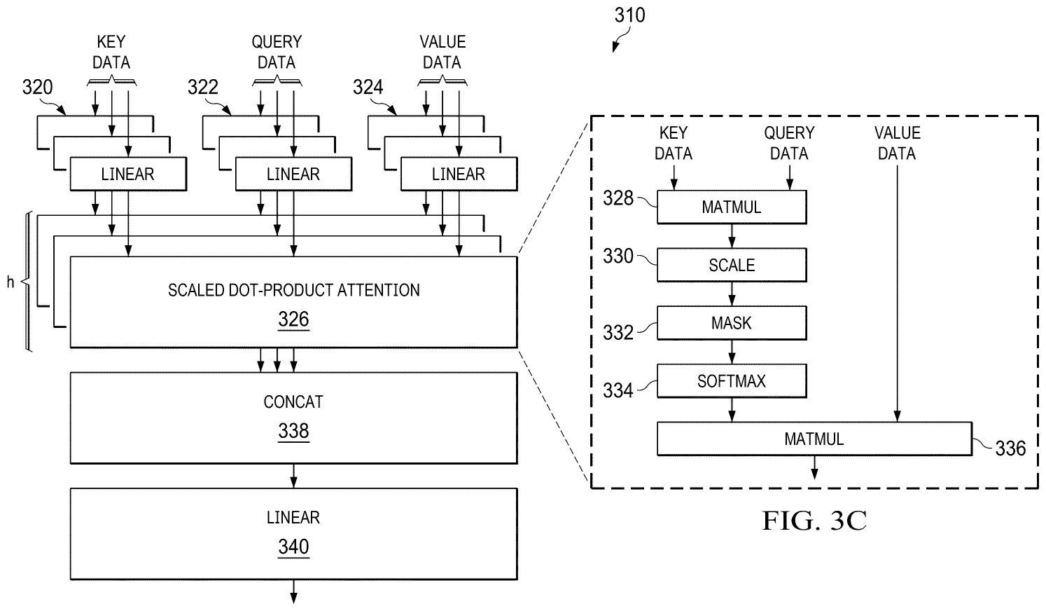

Now turning to the next figure, FIG. 3A illustrates system 300 in an implementation. System 300 is representative of a transformer network configured to perform image classification. For example, system 300 may be representative of transformer network 105 of FIG. 1A. System 300 includes, but is not limited to, image 301, linear projection circuitry 302, transformer encoder 304, and multi-layer perceptron (MLP) network 306.

Image 301 represents the input data for a transformer network. For example, system 300 may be coupled to a camera configured to collect image data of an environment. In an implementation, image 301 is representative of image data collected by a car. For example, a car may include multiple cameras configured to collect image data of the surrounding environment (e.g., cars, pedestrians, etc.) and supply the image data to system 300. In response, system 300 is configured to divide image 301 into a number of patches, herein represented by image patches 303, 305, 307, 309, 311, 313, 315, 317 and 319. Image patches 303, 305, 307, 309, 311, 313, 315, 317 and 319 represent sections of image data which correspond to image 301. In an implementation, image patches 303, 305, 307, 309, 311, 313, 315, 317 and 319 are provided as input to linear projection circuitry 302.

Linear projection circuitry 302 is representative of circuitry configured to embed image data into a format which may be provided to a transformer encoder. For example, linear projection circuitry 302 may be configured to embed image patches 303, 305, 307, 309, 311, 313, 315, 317 and 319 into representations which may be fed to transformer encoder 304. In an implementation, linear projection circuitry 302 is configured to embed image patches 303, 305, 307, 309, 311, 313, 315, 317 and 319 into image matrices. In another implementation, linear projection circuitry 302 is configured to embed image patches 303, 305, 307, 309, 311, 313, 315, 317 and 319 into image vectors. In either case, the output of linear projection circuitry 302 includes embedded patches 323, 325, 327, 329, 331, 333, 335, 337, and 339.

Embedded patches 323, 325, 327, 329, 331, 333, 335, 337, and 339 represent patches of embedded image data. For example, embedded patches 323, 325, 327, 329, 331, 333, 335, 337, and 339 may represent matrices which correspondingly store embedded image data of image patches 303, 305, 307, 309, 311, 313, 315, 317 and 319. For the purposes of explanation, embedded patches 323, 325, 327, 329, 331, 333, 335, 337, and 339 represent image matrices. This is not meant to limit the applications of the proposed technology, but rather to provide an example.

In an implementation, prior to outputting the embedded patches, linear projection circuitry 302 is configured to label embedded patches 323, 325, 327, 329, 331, 333, 335, 337, and 339 with positional embeddings. For example, linear projection circuitry may sequentially label the embedded patches, such that embedded patch 323 is labeled as “1”, embedded patch 325 is labeled as “2”, and so on. Once labeled, linear projection circuitry 302 may provide embedded patches 323, 325, 327, 329, 331, 333, 335, 337, and 339 as input to transformer encoder 304.

Transformer encoder 304 is representative of a deep learning architecture which is configured to employ attention mechanisms for performing the task of system 300. For example, transformer encoder 304 may be representative of encoder 106 of FIG. 1A. In an implementation, transformer encoder 304 employs multi-headed attention mechanisms to perform image classification, later discussed in detail with reference to FIG. 3B.

Input to transformer encoder 304 includes the output of linear projection circuitry 302, as well as classification embedding 321. Classification embedding 321 is representative of learnable data generated during the training stage of system 300. For example, if system 300 is trained to classify images within the automotive context, then classification embedding 321 may provide data which allows transformer encoder 304 to classify vehicles, pedestrians, traffic lights, and other surroundings of the like. In an implementation, linear projection circuitry 302 is configured to label classification embedding 321 with a positional embedding. For example, linear projection circuitry may label classification embedding as “0”. It should be noted that classification embedding 321 may represent an alternative learnable embedding (e.g., detection embedding), but for the purposes of explanation, classification embedding 321 will be discussed herein.

In an implementation, transformer encoder receives classification embedding 321 and embedded patches 323, 325, 327, 329, 331, 333, 335, 337, and 339, and in response, generates an attention-based output. For example, transformer encoder 304 may generate a matrix which stores the final attention scores for image 301. The final attention scores represent data that assigns a relevance to the image data captured by image 301. The relevance of the image data describes the importance of the image data within the context of the task that system 300 is configured to perform. In an implementation, after generating the final attention scores matrix, transformer encoder 304 is configured to provide its output to MLP network 306.

MLP network 306 is representative of a deep learning network which is configured to form the output of system 300. For example, MLP network 306 may comprise multiple layers configured to classify the data of image 301. In an implementation, MLP network 306 is configured to classify image 301 based on the output of transformer encoder 304. For example, MLP network 306 may classify image 301 as a car based on the final attention scores matrix generated by transformer encoder 304.

FIG. 3B illustrates the layers of transformer encoder 304 in an implementation. The layers of transformer encoder 304 are representative of processing layers which are configured to perform various attention-based operations. For example, the layers may execute operations for performing multi-headed attention mechanisms and scaled dot-product attention mechanisms.

In an implementation, transformer encoder 304 is configured to offload the fixed-point computations of its processing layers to an associated hardware accelerator. For example, system 300 may be coupled to a hardware accelerator configured to execute the various fixed-point computations of the transformer network. Transformer encoder 304 includes, but is not limited to, normalization layer 308, multi-headed attention block (MHAB) 310, summation layer 312, normalization layer 314, multi-layer perceptron (MLP) 316, and summation layer 318.

Normalization layer 308 is representative of a processing layer which is configured to generate input data for executing a multi-headed attention mechanism of transformer encoder 304. For example, normalization layer 308 may be representative of block 108 of FIG. 1A. In an implementation, normalization layer 308 is configured to normalize the data of embedded patches 323, 325, 327, 329, 331, 333, 335, 337, and 339 and supply the normalized patches to MHAB 310. In response, MHAB 310 is configured to apply various weight values to the normalized patches to generate key data, query data, and value data for embedded patches 323, 325, 327, 329, 331, 333, 335, 337, and 339.

The query data of an embedded patch is representative of a matrix which describes the perspective of the patch within the input image. For example, the query data of embedded patch 323 may signify that embedded patch 323 represents image patch 303 of image 301. The key data of an embedded patch is representative of a matrix which describes the relationship between the patch and other patches within the input image. For example, the key data of embedded patch 323 may signify that embedded patch 323 comprises image data which corresponds to embedded patches 305 and 309. The value data of an embedded patch is representative of a matrix which describes the actual data of the patch. For example, the value data of embedded patch 323 may store the image data of image patch 303.

MHAB 310 is representative of a processing block configured to execute a multi-headed attention mechanism. For example, MHAB 310 may be representative of MHAB 110 or MHAB 114 of FIG. 1A. In an implementation, MHAB 310 comprises multiple processing layers which are configured to calculate the scaled dot-product attention for each image matrix of the input image. For example, MHAB 310 may include a first matrix multiplication layer (e.g., matrix multiplication layer 119), a SoftMax layer (e.g., SoftMax layer 121), and a second matrix multiplication layer (e.g., matrix multiplication layer 123), later discussed in detail with reference to FIG. 3C. Output of MHAB 310 is provided as input to summation layer 312.

Summation layer 312 is representative of a processing layer which is configured to sum the output of MHAB 310 with the data of embedded patches 323, 325, 327, 329, 331, 333, 335, 337, and 339. In an implementation, the summation operation of summation layer 312 is performed by the associated hardware accelerator. For example, the associated hardware accelerator may sum the output of MHAB 310 with the data of embedded patches 323, 325, 327, 329, 331, 333, 335, 337, and 339. Output of summation layer 312 is provided to normalization layer 314.

Normalization layer 314 is representative of a processing layer which is configured to normalize the output of summation layer 312. For example, normalization layer 314 may normalize the final attention score matrix of image 301. Output of normalization layer 314 is provided to MLP 316.

MLP 316 is representative of a processing block which is configured to linearize the output of normalization layer 314. For example, MLP 316 may linearize the final attention score matrix of image 301. Meaning, MLP 316 may store the data of the final attention score matrix linearly in memory. Output of MLP 316 is provided as input to summation layer 318.

Summation layer 318 is representative of a processing layer which is configured to sum the output of summation layer 312 with the output of MLP 316. For example, summation layer 318 may sum the final attention score matrix of image 301 with the linearized data. In an implementation, the summation operation of summation layer 318 is performed by the associated hardware accelerator. For example, the associated hardware accelerator may sum the output of summation layer 312 with the data of final attention scores matrix. In an implementation, output of summation layer 318 is provided to MLP network 306. In another implementation, the output of summation layer 318 is provided to a next layer of encoder 304. For example, summation layer 318 may provide its output to a normalization layer configured to generate input data for executing another multi-headed attention mechanism of encoder 304. It should be noted that encoder 304 may comprise multiple MHABs configured to determine the scaled dot-product attention of its input.

Additional example details for executing the layers of transformer encoders within the context of transformer networks may be found in the following publication, entitled “An Image is Worth 16×16 Words: Transformers for Image Recognition at Scale” written by Alexey Dosovitskiy et al.

FIG. 3C illustrates the layers of MHAB 310 in an implementation. The layers of MHAB 310 are representative of processing layers which are configured to determine the scaled dot-product attention of an image matrix through a series of fixed-point computations. The scaled dot-product attention is representative of an attention mechanism for determining the normalized attention scores of an input image. MHAB 310 includes, but is not limited to, linearization layers 320, 322, and 324, scaled dot-product attention (SDPA) block 326, concatenation layer 338, and linearization layer 340.

Linearization layers 320, 322, and 324 are correspondingly representative of processing layers which are configured to linearize the key data, query data, and value data of embedded patches within memory. For example, linearization layers 320, 322, and 324, may be configured to correspondingly linearize the key data, query data, and value data of embedded patches 323, 325, 327, 329, 331, 333, 335, 337, and 339 in memory. In an implementation, linearization layers 320, 322, and 324 each include a number of processing layers such that the number of processing layers is equal to the number of supplied embedded patches. For example, linearization layers 320 include nine processing layers for linearizing the key data of embedded patches 323, 325, 327, 329, 331, 333, 335, 337, and 339. Similarly, linearization layers 322 and 324 include nine processing layers for correspondingly linearizing the query data and value data of embedded patches 323, 325, 327, 329, 331, 333, 335, 337, and 339. In an implementation, the linearization operations of linearization layers 320, 322, and 324 are performed by an associated hardware accelerator. Output of linearization layers 320, 322, and 324 is supplied to SDPA block 326.

SDPA block 326 is representative of a processing block which is configured to determine the scaled dot-product attention of embedded data. For example, SDPA block 326 may be configured to determine the scaled dot-product attention of embedded patches 323, 325, 327, 329, 331, 333, 335, 337, and 339. In an implementation, SDPA block includes a number of SDPA processing layers, such that the number of SDPA processing layers is equal to the number of supplied embedded patches. For example, SDPA block 326 may include nine processing layers for determining the scaled-dot-product attention of embedded patches 323, 325, 327, 329, 331, 333, 335, 337, and 339. In an implementation, each SDPA processing layer of SDPA block 326 includes matrix multiplication layer 328, scale layer 330, mask layer 332, SoftMax layer 334, and matrix multiplication layer 336.

Matrix multiplication layer 328 is representative of a processing layer configured to perform a matrix multiplication operation with respect to the key data and query data of an embedded patch. For example, matrix multiplication layer 328 may be representative of matrix multiplication layer 119 of FIG. 1B. In an implementation, the matrix multiplication operation of matrix multiplication layer 328 is performed by an associated hardware accelerator. For example, system 300 may include a hardware accelerator configured to execute the fixed-point computations of SDPA block 326.

In an implementation, to perform the matrix multiplication operation of matrix multiplication layer 328, the hardware accelerator is configured to read in the linearized key data of an embedded patch from memory and write the linearized key data to a left matrix input of the matrix multiplication operation. Next, the hardware accelerator is configured to transpose-read in the linearized query data of the embedded patch from memory and write the transpose-read query data to a right matrix input of the matrix multiplication operation. Once written, the hardware accelerator is configured to produce a first result matrix by matrix multiplying the left matrix input with the right matrix input. The first result matrix is representative of a matrix which stores the attention scores of the embedded patch (e.g., embedded patch 323). In an implementation, matrix multiplication layer 328 is configured to supply the first result matrix to scale layer 330.

Scale layer 330 is representative of a processing layer configured to scale the output of matrix multiplication layer 328. For example, scale layer 330 may be configured to format the data of the first result matrix into a representation which is better suited for executing SoftMax layer 334 by applying a scaling value to the first result matrix. In an implementation, the scaling operation of scale layer 330 is executed by an associated hardware accelerator. For example, the associated hardware accelerator may be configured to apply the scaling value to the first result matrix. Output of scale layer 330 is supplied to mask layer 332 (or SoftMax layer 334).

Mask layer 332 is representative of an optional processing layer which is configured to mask the output of scale layer 330. For example, mask layer 332 may be configured to format the output of scale layer 330 into a representation which is better suited for executing SoftMax layer 334 by masking the invalid values of the scaled first result matrix. In an implementation, the masking operation of mask layer 332 is executed by an associated hardware accelerator. For example, the associated hardware accelerator may be configured to mask the invalid data of the scaled first result matrix. Output of mask layer 332 is supplied to SoftMax layer 334. It should be noted that, if SDPA block 326 does not include mask layer 332, then scale layer 330 is configured to supply its output to SoftMax layer 334.

SoftMax layer 334 is representative of a processing layer configured to perform a SoftMax operation. For example, SoftMax layer 334 may be representative of SoftMax layer 121 of FIG. 1B. In an implementation, the SoftMax operation of SoftMax layer 334 is performed by the associated hardware accelerator. For example, the associated hardware accelerator may be configured to execute a height-wise SoftMax operation with respect to the output of mask layer 332 (or scale layer 330) to generate a second result matrix. The second result matrix is representative of a matrix which stores the normalized attention scores of the first result matrix. In an implementation, after generating the second result matrix, the hardware accelerator is configured to transpose-write the second result matrix to memory. For example, after executing the SoftMax operation of SoftMax layer 334, the associated hardware accelerator may transpose-write the second result matrix to memory. Once written, SoftMax layer 334 is configured to provide the transpose-written second result matrix as input to matrix multiplication layer 336.

Matrix multiplication layer 336 is representative of a processing layer configured to perform a matrix multiplication operation with respect to the transpose-written second result and the value data of an embedded patch. For example, matrix multiplication layer 336 may be representative of matrix multiplication layer 123 of FIG. 1B. In an implementation, the matrix multiplication operation of matrix multiplication layer 336 is performed by an associated hardware accelerator. For example, the associated hardware accelerator may be configured to read in the transpose-written second result matrix from memory and write the transpose-written second result matrix to a left matrix input of the matrix multiplication operation. Next, the hardware accelerator may be configured to read in the value data of an embedded patch from memory and write the value data to a right matrix input of the matrix multiplication operation. Once written, the hardware accelerator is configured to produce a third result matrix by matrix multiplying the left matrix input with the right matrix input.

The third result matrix is representative of a matrix which stores the final attention scores of the embedded patch. In an implementation the third result matrix of each embedded patch is supplied as input to concatenation layer 338. For example, after SDPA block 326 generates the third result matrices for each patch of embedded patches 323, 325, 327, 329, 331, 333, 335, 337, and 339, SDPA block 326 may supply each third result matrix to concatenation layer 338.

Concatenation layer 338 is representative of a processing layer configured to concatenate the output of SDPA block 326 into a singular matrix. For example, concatenation layer 338 may concatenate the third result matrices of embedded patches 323, 325, 327, 329, 331, 333, 335, 337, and 339 into a singular matrix. In an implementation, the concatenation operation of concatenation layer 338 is performed by an associated hardware accelerator. Output of concatenation layer 338 is suppled as input to linearization layer 340.

Linearization layer 340 is representative of processing layer configured to linearize the output of concatenation layer 338. For example, linearization layer 340 may receive the output matrix of concatenation layer 338, and in response, linearize the data of the output matrix in memory. In an implementation, the linearization operation of linearization layer 340 is performed by an associated hardware accelerator. Output of linearization layer 340 is supplied to summation layer 312.

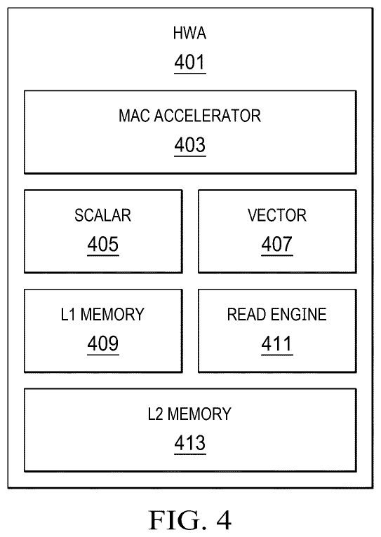

Now turning to the next figure, FIG. 4 illustrates hardware accelerator 401 in an implementation. Hardware accelerator 401 is representative of circuitry configured to perform fixed-point computations. For example, hardware accelerator 401 may be representative of circuitry configured to execute the fixed-point computations of a transformer network (e.g., transformer network 105 or system 300). In an implementation, hardware accelerator 401 represents a SIMD architecture. Hardware accelerator 401 includes multiply-accumulate (MAC) accelerator 403, scalar register 405, vector register 407, L1 memory 409, read engine 411, and L2 memory 413

MAC accelerator 403 is representative of circuitry configured to perform multiply and accumulate operations. For example, MAC accelerator 403 may be configured to perform the various fixed-point computations of a transformer encoder (e.g., encoder 106 or transformer encoder 304). In an implementation, MAC accelerator 403 is configured to gather input data for performing the multiply and accumulate operations from scalar register 405 and vector register 407.

Scalar register 405 and vector register 407 are representative of registers configured to store input data for performing a fixed-point computation. For example, in the context of a transformer network, scalar register 405 may store a scaling value while vector register 407 stores the query data of an embedded image patch (e.g., embedded patch 323). In an implementation, the input data for scalar register 405 is stored in LI memory 409, while the input data for vector register 407 is stored in L2 memory 413.

L1 memory 409 and L2 memory 413 are representative of memories configured to store data related to fixed-point computations. For example, L1 memory 409 and L2 memory 413 may store data related to the attention-based operations of a transformer network. In an implementation, L1 memory 409 is configured to store scaling values for scalar register 405, while L2 memory 413 is configured to store embedded image data. For example, in the context of system 300, L2 memory 413 may be configured to store key data, query data, and value data of embedded patches 323, 325, 327, 329, 331, 333, 335, 337, and 339. In an implementation, read engine 411 is configured to access data from L1 memory 409 and L2 memory 413 and provide the accessed data to the corresponding register.

Read engine 411 is representative of circuitry configured to read in data from, or write data to, memory. For example, read engine 411 may read in data from L2 memory 413 and write the data to vector register 407. Alternatively, read engine 411 may read in data from an off-chip memory and write the data to L2 memory 413. In an implementation, read engine 411 may be configured to perform transpose-read and transpose-write operations. For example, in the context of a transformer encoder, read engine 411 may be configured to transpose-read in query data from L2 memory 413 and write the transpose-read query data to vector register 407. Alternatively, read engine 411 may be configured to transpose-write SoftMax operation results to L2 memory 413.

Advantageously, utilizing the transpose-read and transpose-write capabilities of read engine 411 negates the necessity of transpose layers within a transformer network. Furthermore, the use of the transpose-read and transpose-write capabilities allows for MAC accelerator 403 to efficiently execute non-linear operations (e.g., SoftMax operations, normalization operations, etc.) of a transformer network.

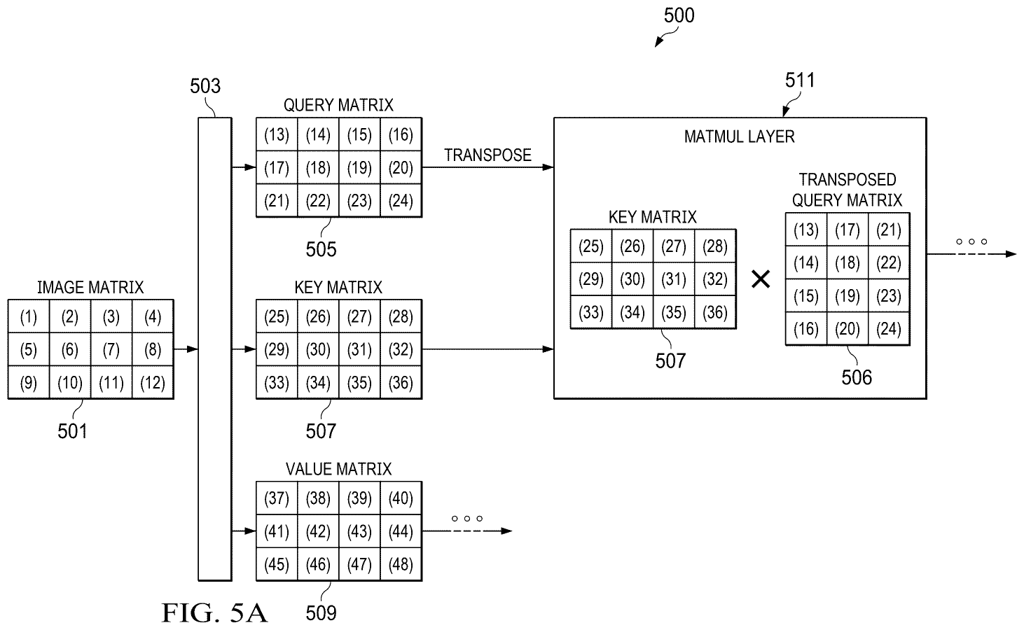

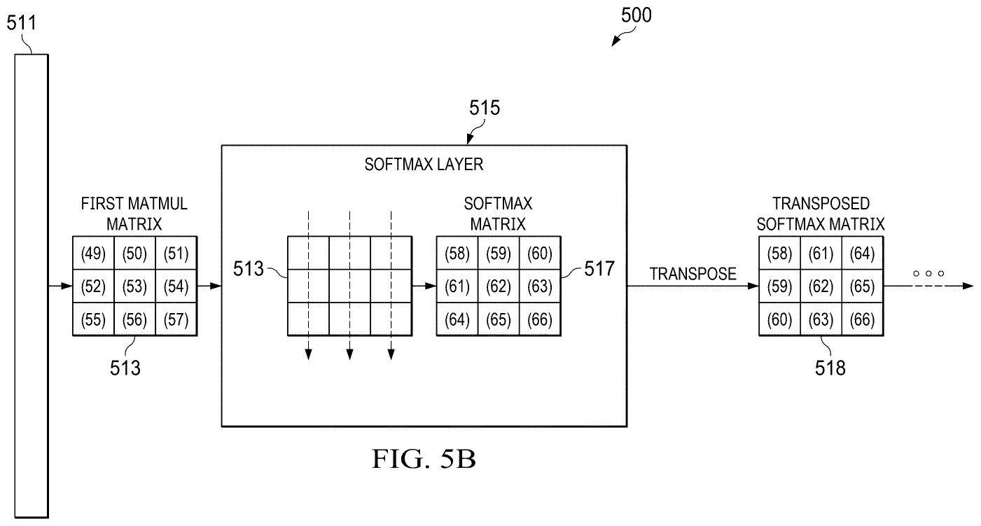

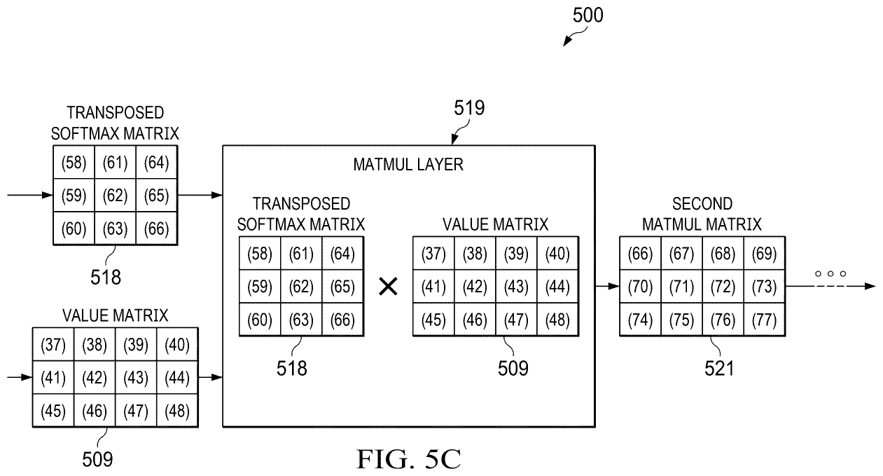

FIGS. 5A-5C illustrate operational scenario 500 in an implementation. Operational scenario 500 is representative of a scenario for executing the layers of a transformer encoder. For example, operational scenario 500 may be representative of a scenario for executing the layers of encoder 106 or the layers of MHAB 310. In an implementation, operational scenario 500 includes three stages. The first stage, depicted by FIG. 5A, is representative of a scenario for generating input data for a transformer encoder and executing a first matrix multiplication operation with respect to the input data. The second stage, depicted by FIG. 5B, is representative of a scenario for executing a SoftMax operation with respect to the result of the first matrix multiplication operation. The third stage, depicted by FIG. 5C, is representative of a scenario for executing a second matrix multiplication operation with respect to the input data and the result of the SoftMax operation.

Now turning to the first stage, FIG. 5A includes image matrix 501, layer 503, and matrix multiplication layer 511. Image matrix 501 is representative of input to a transformer network. For example, in the context of FIG. 3, image matrix 501 may represent image 301 or an output of linear projection circuitry 302. Alternatively, image matrix 501 may represent the output of a previous attention mechanism. For the purposes of explanation, image matrix 501 is representative of an embedded patch of image data (e.g., embedded patch 323). Meaning, image matrix 501 represents a section of an input image which has been embedded into a readable format. This specification is not meant to limit the applications of operational scenario 500, but rather to provide an example. In an implementation, image matrix 501 is supplied as input to layer 503.

Layer 503 is representative of a processing layer configured to generate input data for a multi-headed attention mechanism. For example, layer 503 may be representative of a matrix multiplication layer. In an implementation, layer 503 is supplied with image matrix 501, and in response, is configured to generate query data, key data, and value data based on image matrix 501. For example, layer 503 may generate query matrix 505, key matrix 507, and value matrix 509 based on image matrix 501.

Query matrix 505 is representative of a matrix which stores data that describes the perspective of image matrix 501 within the input image. Key matrix 507 is representative of a matrix which stores data that describes the relationship between image matrix 501 and the other image matrices of the input image. Value matrix 509 is representative of a matrix which stores the data of image 501. In an implementation, query matrix 505 and key matrix 507 further represent input to matrix multiplication layer 511.

Matrix multiplication layer 511 is representative of a processing layer (e.g., matrix multiplication layer 119 or matrix multiplication layer 328) which is configured to perform a matrix multiplication operation with respect to the query data and key data of an associated image matrix. For example, matrix multiplication layer 511 may be configured to perform a matrix multiplication operation with respect to query matrix 505 and key matrix 507 of image matrix 501. In an implementation, to perform the matrix multiplication operation of matrix multiplication layer 511, matrix multiplication layer 511 is configured to offload the execution of the matrix multiplication operation to an associated hardware accelerator. For example, the matrix multiplication operation of matrix multiplication layer 511 may be executed by hardware accelerator 401.

In a brief operational example, to execute the matrix multiplication operation of matrix multiplication layer 511, hardware accelerator 401 is first configured to read in key matrix 507 from memory and supply key matrix 507 to a left matrix input of the matrix multiplication operation. For example, read engine 411 may read in key matrix 507 from L2 memory 413 and write key matrix 507 to vector register 407. Next, hardware accelerator 401 is configured to transpose-read in query matrix 505 from memory and supply the transposed-read matrix to a right matrix input of the matrix multiplication operation. For example, read engine 411 may transpose-read in query matrix 505 from L2 memory 413, and in turn, write transposed query matrix 506 to vector register 407.

Once written, MAC accelerator 403 is configured to execute the matrix multiplication operation of matrix multiplication layer 511 with respect to the left matrix input (storing key matrix 507) and the right matrix input (storing transposed query matrix 506). As a result, MAC accelerator 403 generates a first result matrix. The first result matrix is representative of a matrix which stores the attention scores for the associated image matrix. For example, the first result matrix may store the attention scores for image matrix 501. In an implementation the first result matrix is stored in L2 memory 413.

Now turning to the next stage of operational scenario 500, FIG. 5B includes matrix multiplication layer 511, result matrix 513, SoftMax layer 515, and transposed SoftMax matrix 518. Result matrix 513 is representative of the output of matrix multiplication layer 511. More specifically, result matrix 513 represents the outcome of matrix multiplying key matrix 507 with transposed query matrix 506. In an implementation, result matrix 513 is further representative of the input to SoftMax layer 515.

SoftMax layer 515 is representative of a processing layer (e.g., SoftMax layer 121 or SoftMax layer 334) which is configured to perform a SoftMax operation with respect to the output of matrix multiplication layer 511. For example, SoftMax layer 515 may be configured to perform a SoftMax operation on result matrix 513. A SoftMax operation is representative of a fixed-point computation for normalizing the attention scores of result matrix 513. In an implementation, to perform the SoftMax operation of matrix multiplication layer 511, matrix multiplication layer 511 is configured to offload the execution of the SoftMax operation to an associated hardware accelerator. For example, the SoftMax operation of SoftMax layer 515 may be executed by hardware accelerator 401.

In a brief operational example, to execute the SoftMax operation of SoftMax layer 515, hardware accelerator 401 is first configured to read in result matrix 513 from memory and supply result matrix 513 as input to the SoftMax operation. For example, read engine 411 may read result matrix 513 from L2 memory 413 and write result matrix 513 to vector register 407. Once written, MAC accelerator 403 is configured to execute a height-wise SoftMax operation on result matrix 513 to generate SoftMax matrix 517. SoftMax matrix 517 is representative of a matrix which stores the normalized attention scores of result matrix 513. In an implementation, when writing SoftMax matrix 517 to memory, read engine 411 is configured to perform a transpose-write operation on the data of SoftMax matrix 517 to generate transposed SoftMax matrix 518.

Now turning to the final stage of operational scenario 500, FIG. 5C includes transposed SoftMax matrix 518, value matrix 509, matrix multiplication layer 519, and result matrix 521. Matrix multiplication layer 519 is representative of a processing layer (e.g., matrix multiplication layer 123 or matrix multiplication layer 336) which is configured to perform a matrix multiplication operation with respect to an output of a SoftMax operation and value data of an associated image matrix. For example, matrix multiplication layer 519 may be configured to perform a matrix multiplication operation with respect to transposed SoftMax matrix 518 and value matrix 509.

In an implementation, to perform the matrix multiplication operation of matrix multiplication layer 519, matrix multiplication layer 519 is configured to offload the execution of the matrix multiplication operation to an associated hardware accelerator. For example, the matrix multiplication operation of matrix multiplication layer 519 may be executed by hardware accelerator 401.

In a brief operational example, to execute the matrix multiplication operation of matrix multiplication layer 519, hardware accelerator 401 is first configured to read in transposed SoftMax matrix 518 from memory and supply transposed SoftMax matrix 518 to a left matrix input of the matrix multiplication operation. For example, read engine 411 may read in transposed SoftMax matrix 518 from L2 memory 413 and write transposed SoftMax matrix 518 to vector register 407. Next, hardware accelerator 401 is configured to read in value matrix 509 from memory and supply value matrix 509 to a right matrix input of the matrix multiplication operation. For example, read engine 411 may read in value matrix 509 from L2 memory 413 and write value matrix 509 to vector register 407.

Once written, MAC accelerator 403 is configured to execute the matrix multiplication operation of matrix multiplication layer 519 with respect to the left matrix input (storing transposed SoftMax matrix 518) and the right matrix input (storing value matrix 509). As a result, MAC accelerator 403 generates a second result matrix, herein referred to as result matrix 521. Result matrix 521 is representative of a matrix which stores the final attention scores for image matrix 501. In an implementation, result matrix 521 is provided to the next layer of the transformer network. For example, result matrix 521 may be provided to an MLP network (e.g., MLP network 306) which is configured to form an output for the transformer network.

It should be noted that operational scenario 500 repeats for each embedded patch of an input image. For example, in the context of system 300, operational scenario 500 is executed by each SDAP processing layer of SDAP block 3296.

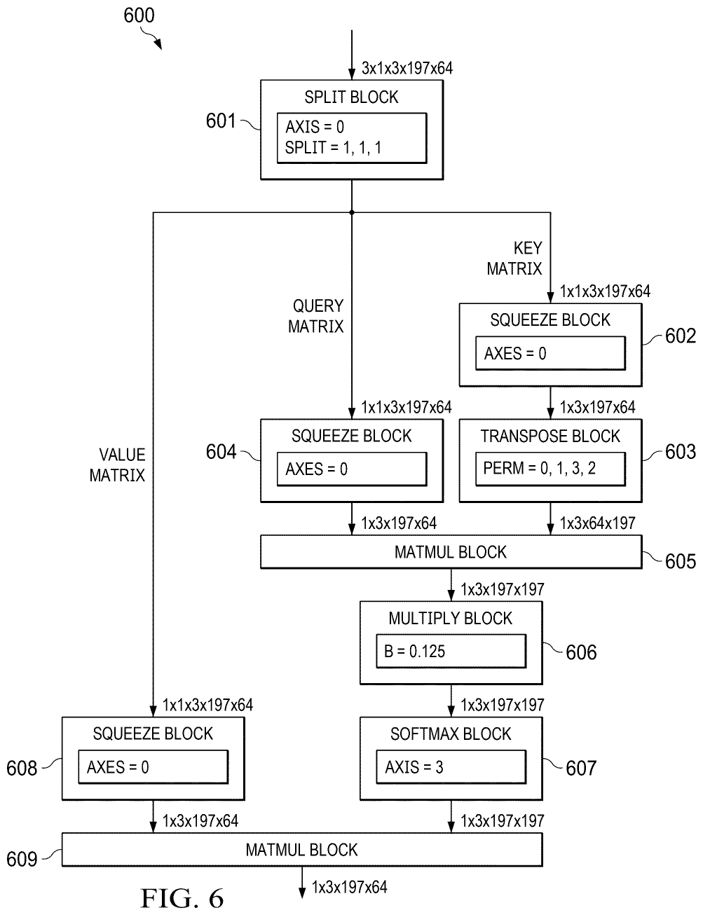

FIG. 6 illustrates attention mechanism 600 in an implementation. Attention mechanism 600 is representative of an alternative design for executing the multi-headed attention mechanism of a transformer network (e.g., transformer network 105 or system 300). More specifically, attention mechanism 600 illustrates an exemplary software flow for computing the scaled dot-product attention of an input image. The scaled dot-product attention is representative of an attention mechanism for determining the normalized attention scores of an input image. In an implementation, attention mechanism 600 is executed by processing circuitry (e.g., processing circuitry 103) configured to perform a designated task. Attention mechanism 600 includes split block 601, squeeze block 602, transpose block 603, squeeze block 604, matrix multiplication block 605, multiplication block 606, SoftMax block 607, squeeze block 608, and matrix multiplication block 609.

Split block 601 is representative of a software block which is configured to generate input data for computing the scaled dot-product attention of an input image. For example, split block 601 may represent block 108 of FIG. 1A. Input to split block 601 includes embedded image data, while the output includes query data, key data, and value data. For example, input to split block 601 may include an image matrix, while the output includes a query matrix, key matrix, and value matrix. In an implementation split block 601 provides the generated key matrix to squeeze block 602, the generated query matrix to squeeze block 604, and the generated value matrix to squeeze block 608.

Squeeze blocks 602, 604, and 608 represent software blocks which are configured to decrease the dimensions of their respective input data. For example, input to squeeze blocks 602, 604, and 608 may include 1×1×3×197×64 matrices, while the output includes 1×3×197×64 matrices. In an implementation squeeze block 602 provides its output to transpose block 603, squeeze block 604 provides its output to matrix multiplication block 605, and squeeze block 608 provides its output to matrix multiplication block 609.

Transpose block 603 is representative of a software block which is configured to perform a transpose operation. Input to transpose block 603 includes the output of squeeze block 602, while the output includes a transposed output. For example, input to transpose block 603 may include a 1×3×197×64 key matrix while the output includes a 1×3×64×197 key matrix. In an implementation, to execute the transpose operation of transpose block 603, the processing circuitry is configured to instruct an associated hardware accelerator to perform the transpose operation. For example, the processing circuitry may instruct hardware accelerator 401 to perform the transpose operation of transpose block 603.

It should be noted that, instructing the hardware accelerator to perform the transpose operation is not synonymous with configuring the hardware accelerator to perform transpose- read and transpose-write operations. For example, if hardware accelerator 401 is instructed to perform a transpose operation, then hardware accelerator 401 must gather the relevant data from a current location before performing the transpose operation. Alternatively, if hardware accelerator 401 is configured to perform transpose-read and transpose-write operations, then hardware accelerator 401 may transpose the relevant data directly from its current location. In either case, output of hardware accelerator 401 includes the transposed key matrix, which is provided as input to matrix multiplication block 605.

Matrix multiplication block 605 is representative of a software block which is configured to perform a matrix multiplication operation. For example, matrix multiplication block 605 may be representative of matrix multiplication layer 119 of FIG. 1B or matrix multiplication layer 328 of FIG. 3C. Input to matrix multiplication block 605 includes the outputs of squeeze block 604 and transpose block 603, while the output includes a result of the matrix multiplication operation. For example, input to matrix multiplication block 605 may include a 1×3×197×64 query matrix and 1×3×64×197 key matrix, while the output includes a 1×3×197×197 result matrix.

In an implementation, to execute the matrix multiplication operation of matrix multiplication block 605, the processing circuitry is configured to instruct an associated hardware accelerator to perform the matrix multiplication operation. For example, the processing circuitry may instruct hardware accelerator 401 to supply the query matrix as a left matrix input to the matrix multiplication operation, supply the transposed key matrix as a right matrix input to the matrix multiplication operation, and execute the matrix multiplication operation with respect to the left and right matrix inputs. As a result, hardware accelerator 401 outputs the result matrix of matrix multiplication block 605 to multiplication block 606.

Multiplication block 606 is representative of a software block which is configured to scale the output of matrix multiplication block 605. For example, multiplication block 606 may be representative of scale layer 330 of FIG. 3C. In an implementation, to execute the multiplication operation of multiplication block 606, the processing circuitry is configured to instruct an associated hardware accelerator to perform the multiplication operation. For example, the processing circuitry may instruct hardware accelerator 401 to multiply the result matrix of matrix multiplication block 605 by a scaling factor (e.g., 0.125). In an implementation multiplication block 606 provides its output to SoftMax block 607.

SoftMax block 607 is representative of a software block which is configured to perform a SoftMax operation. For example, SoftMax block 607 may be representative of SoftMax layer 121 of FIG. 1B or SoftMax layer 334 of FIG. 3C. Input to SoftMax block 607 includes the output of multiplication block 606, while the output includes a result of the SoftMax operation. In an implementation, to execute the SoftMax operation of SoftMax block 607, the processing circuitry is configured to instruct an associated hardware accelerator to perform the SoftMax operation. For example, the processing circuitry may instruct hardware accelerator 401 to perform a width-wise SoftMax operation on the output matrix of multiplication block 606. As a result, hardware accelerator 401 outputs the result matrix of SoftMax block 607 to matrix multiplication block 609.

Matrix multiplication block 609 is representative of a software block which is also configured to perform a matrix multiplication operation. For example, matrix multiplication block 609 may be representative of matrix multiplication layer 123 of FIG. 1B or matrix multiplication layer 336 of FIG. 3C. Input to matrix multiplication block 609 includes the outputs of SoftMax block 607 and squeeze block 608, while the output includes a result of the matrix multiplication operation. For example, input to matrix multiplication block 605 may include a 1×3×197×197 SoftMax matrix and 1×3×197×64 value matrix, while the output includes a 1×3×197×64 result matrix.

In an implementation, to execute the matrix multiplication operation of matrix multiplication block 609, the processing circuitry is configured to instruct an associated hardware accelerator to perform the matrix multiplication operation. For example, the processing circuitry may instruct hardware accelerator 401 to supply the SoftMax matrix as a left matrix input to the matrix multiplication operation, supply the value matrix as a right matrix input to the matrix multiplication operation, and execute the matrix multiplication operation with respect to the left and right matrix inputs. As a result, hardware accelerator 401 outputs the result matrix of matrix multiplication block 609. The result matrix of matrix multiplication block 609 is representative of a matrix which stores the scaled-dot-product attention of the original input image.

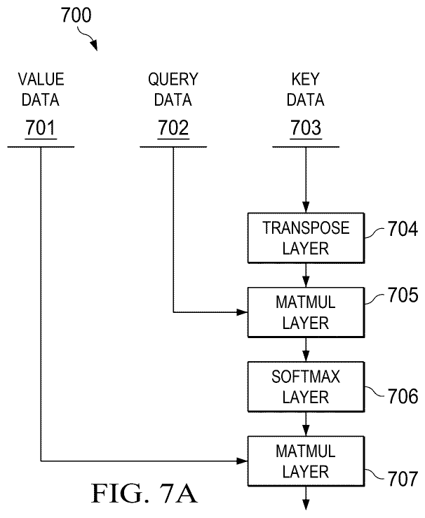

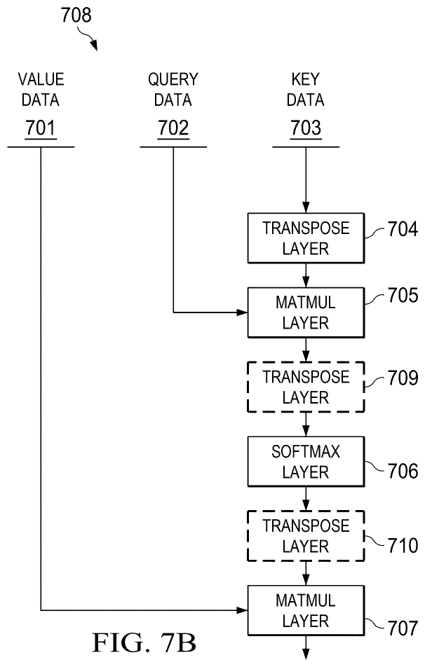

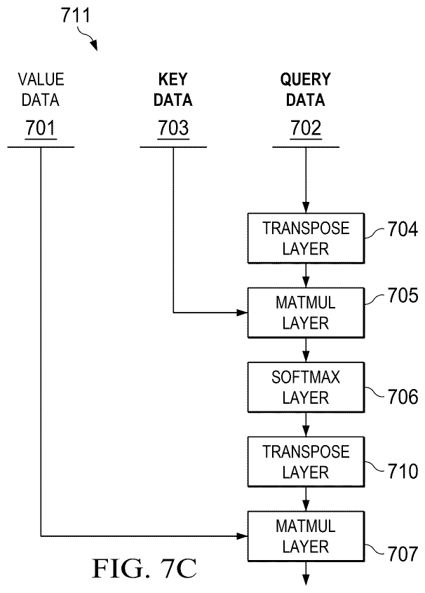

Now turning to the next figure, FIG. 7A illustrates operational scenario 700 in an implementation. Operational scenario 700 is representative of a scenario for executing the multiheaded attention mechanism of a transformer network (e.g., transformer network 105 or system 300). More specifically, operational scenario 700 depicts a scenario for computing the scaled dot-product attention of an input image. For example, operational scenario 700 may be representative of a scenario for executing attention mechanism 600. Operational scenario 700 includes value data 701, query data 702, key data 703, transpose layer 704, matrix multiplication layer 705, SoftMax layer 706, and matrix multiplication layer 707.

Value data 701, query data 702, and key data 703 represent the inputs to a multi-headed attention mechanism. For example, value data 701 may be representative of value matrix 509, query data 702 may be representative of query matrix 505, and key data 703 may be representative of key matrix 507. In an implementation, value data 701 is supplied as input to matrix multiplication layer 707, query data 702 is supplied as input to matrix multiplication layer 705, and key data 703 is supplied as input to transpose layer 704.

Transpose layer 704 is representative of a processing layer configured to perform a transpose operation. For example, transpose layer 704 may be representative of transpose block 603 of FIG. 6. Input to transpose layer 704 includes key data 703, and output of transpose layer 704 includes transposed key data. In an implementation, the transpose operation of transpose layer 704 is executed by an associated hardware accelerator. For example, processing circuitry configured to execute the layers of a transformer network may instruct an associated hardware accelerator to perform the transpose operation of transpose layer 704. It should be noted that, instructing the hardware accelerator to perform the transpose operation is not synonymous with configuring the hardware accelerator to perform transpose-read and transpose-write operations. Output of transpose layer 704 is provided to matrix multiplication layer 705.

Matrix multiplication layer 705 is representative of a processing layer which is configured to perform a matrix multiplication operation. For example, matrix multiplication layer 705 may be representative of matrix multiplication layer 119, matrix multiplication layer 328, or matrix multiplication block 605. Input to matrix multiplication layer 705 includes query data 702 and the transposed key data, while the output includes a result of the matrix multiplication operation.

In an implementation, the matrix multiplication operation of matrix multiplication layer 705 is executed by an associated hardware accelerator. For example, processing circuitry may instruct an associated hardware accelerator to supply query data 702 to a left matrix input of the matrix multiplication operation and supply the transposed key data to a right matrix input of the matrix multiplication operation. Next, the processing circuitry instructs the hardware accelerator to execute the matrix multiplication operation with respect to the left matrix input and the right matrix input and output a result of the matrix multiplication operation. Output of matrix multiplication layer 705 is provided as input to SoftMax layer 706.

SoftMax layer 706 is representative of a processing layer which is configured to perform a SoftMax operation. For example, SoftMax layer 706 may be representative of SoftMax layer 121, SoftMax layer 334, or SoftMax block 607. Input to SoftMax layer 706 includes the output data of matrix multiplication layer 705, while the output includes a result of the SoftMax operation. In an implementation, the SoftMax operation of SoftMax layer 706 is executed by an associated hardware accelerator. For example, processing circuitry may instruct an associated hardware accelerator to perform a width-wise SoftMax operation on the output data of matrix multiplication layer 705. Output of SoftMax layer 706 is then provided as input to matrix multiplication layer 707.

Matrix multiplication layer 707 is representative of a processing layer which is also configured to perform a matrix multiplication operation. For example, matrix multiplication layer 707 may be representative of matrix multiplication layer 123, matrix multiplication layer 336, or matrix multiplication block 609. Input to matrix multiplication layer 707 includes the output of SoftMax layer 706 and value data 701, while the output includes a result of the matrix multiplication operation.

In an implementation, the matrix multiplication operation of matrix multiplication layer 707 is also executed by an associated hardware accelerator. For example, processing circuitry may instruct an associated hardware accelerator to supply the output data of SoftMax layer 706 to a left matrix input of the matrix multiplication operation and supply value data 701 to a right matrix input of the matrix multiplication operation. Next, the processing circuitry instructs the hardware accelerator to execute the matrix multiplication operation with respect to the left matrix input and the right matrix input and output a result of the matrix multiplication operation. Output of matrix multiplication layer 707 is representative of data which describes the scaled-dot-product attention of the original input image.

Problematically, operational scenario 700 is less efficient than designs which employ height-wise SoftMax operations. Furthermore, operational scenario 700 is less efficient than designs which configure the hardware accelerator to perform transpose-read and transpose-write operations.

FIG. 7B illustrates operational scenario 708 in an implementation. Operational scenario 708 is representative of an alternative scenario for computing the scaled dot-product attention of an input image. More specifically, operational scenario 708 depicts an alternative design to operational scenario 700. As such, operational scenario 708 also includes value data 701, query data 702, key data 703, transpose layer 704, matrix multiplication layer 705, SoftMax layer 706, and matrix multiplication layer 707, as well as transpose layer 709, and transpose layer 710.

Transpose layers 709 and 710 are representative of processing layers which are configured to perform a transpose operation. Input to transpose layer 709 includes the output of matrix multiplication layer 705, while input to transpose layer 710 includes the output of SoftMax layer 706. In an implementation, the transpose operations of transpose layers 709 and 710 are executed by an associated hardware accelerator. For example, processing circuitry configured to execute the layers of a transformer network may instruct an associated hardware accelerator to perform the transpose operations of transpose layers 709 and 710.

Advantageously, the addition of transpose layers 709 and 710 allows SoftMax layer 706 to perform a height-wise SoftMax operation, thereby improving the efficiency of SoftMax layer 706. Problematically, the addition of extra transpose layers negates the efficiency which is gained by performing a height-wise SoftMax operation.

FIG. 7C illustrates operational scenario 711 in an implementation. Operational scenario 711 is representative of another alternative scenario for computing the scaled dot-product attention of an input image. More specifically, operational scenario 711 depicts an alternative design to operational scenarios 700 and 708. As such, operational scenario 711 also includes value data 701, query data 702, key data 703, transpose layer 704, matrix multiplication layer 705, SoftMax layer 706, matrix multiplication layer 707, and transpose layer 710, but does not include transpose layer 709.

In contrast to operational scenarios 700 and 708, operational scenario 711 takes advantage of the fundamentals of matrix multiplications by utilizing the transpose property. The transpose property of matrix multiplication may be represented by the following equation:

(AB′)′=BA′

Such that A is representative of a first matrix (e.g., query data 702) and B is representative of a second matrix (e.g., key data 703). On the left side of the equation above, A is the left matrix input for the matrix multiplication operation, and B′ is the right matrix input for the matrix multiplication operation. On the right side of the equation above, B is the left matrix input for the matrix multiplication operation, and A′ is the right matrix input for the matrix multiplication operation.

In an implementation, to utilize the transpose property of matrix multiplications, key data 703 is supplied as a left matrix input to matrix multiplication layer 705, and query data 702 is transposed and provided as a right matrix input to matrix multiplication layer 705.

Advantageously, by utilizing the above transpose property, operational scenario 711 no longer requires transpose layer 709. Furthermore, SoftMax layer 706 is still allowed to perform a height-wise SoftMax operation. Problematically, operational scenario 711 is still less efficient than alternative designs since operational scenario 711 requires a hardware accelerator to execute transpose layers 704 and 710.

In an implementation, to improve the efficiency of operational scenario 711, the associated hardware accelerator may be configured to perform transpose-read and transpose-write operations. For example, the associated hardware accelerator may be configured to transpose-read query data 702 from memory, thusly eliminating the need to perform a transpose operation. Such an example may be found within the description of FIG. 1B.

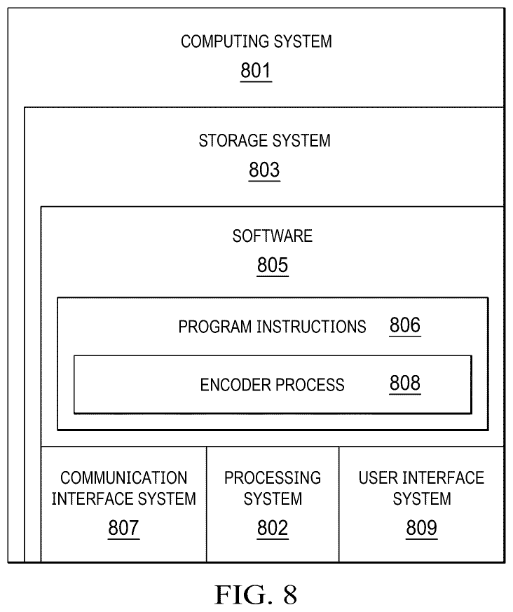

FIG. 8 illustrates an example computer system that may be used in various implementations. For example, computing system 801 is representative of a computing device capable of efficiently executing the layers of a transformer encoder within the context of a transformer network as described herein. Computing system 801 is representative of any system or collection of systems with which the various operational architectures, processes, scenarios, and sequences disclosed herein for executing the attention mechanisms of a transformer encoder may be employed. Examples of computing system 801 include-but are not limited to-micro controller units (MCUs), embedded computing devices, server computers, cloud computers, personal computers, mobile phones, and the like.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809. Computing system 801 may be representative of a cloud computing device, distributed computing device, or the like.

Processing system 802 loads and executes software 805 from storage system 803, or alternatively, runs software 805 directly from storage system 803. Software 805 includes program instructions 806, which includes encoder process 808 (e.g., method 200). When executed by processing system 802, software 805 directs processing system 802 to operate as described herein for at least the various processes, operational scenarios, and sequences discussed in the foregoing implementations. Computing device 801 may optionally include additional devices, features, or functions not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, digital signal processing units, data processing units, application specific processors, and logic devices, as well as any other type of processing device, combinations, or variations thereof.

Storage system 803 may comprise any computer readable storage media readable and writeable by processing system 802 and capable of storing software 805. Storage system 803 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions 806 and among other functions may, when executed by processing system 802, direct processing system 802 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support binary convolution operations. Indeed, encoding software 805 (and encoder process 808) on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
generating embedding data based on sensor data;
generating key data, query data, and value data based on the embedding data;
performing a first matrix multiplication operation using the key data and the query data to produce a first result by at least generating a value in the first result using a row of the key data and a column of the query data;
performing a SoftMax operation on the first result to produce a second result; and
performing a second matrix multiplication operation using the second result and the value data.

2. The method of claim 1, wherein performing the first matrix multiplication operation comprises:
supplying the key data as a left matrix input to the first matrix multiplication operation;
supplying the query data as a right matrix input to the first matrix multiplication operation; and
matrix multiplying the left matrix input with the right matrix input.

3. The method of claim 2, wherein supplying the query data as the right matrix input comprises transpose-reading the query data from memory and supplying the query data in a transposed form to the right matrix input.

4. The method of claim 1, further comprising transpose-writing the second result to a memory, resulting in a transpose-written second result, wherein performing the second matrix multiplication operation using the second result and the value data comprises performing the second matrix multiplication operation using the transpose-written second result and the value data.

5. The method of claim 4, wherein performing the second matrix multiplication operation comprises:
supplying the transpose-written second result as a left matrix input to the second matrix multiplication operation;
supplying the value data as a right matrix input to the second matrix multiplication operation; and
matrix multiplying the left matrix input with the right matrix input.

6. The method of claim 1, further comprising outputting a third result based on an output of the second matrix multiplication operation.

7. The method of claim 1, wherein performing the SoftMax operation comprises performing a height-wise SoftMax operation on the first result.

8. The method of claim 1, wherein the first matrix multiplication operation, the SoftMax operation, and the second matrix multiplication operation are performed within a context of an encoder within a vision transformer network.

9. A non-transitory computer-readable medium having executable instructions stored thereon, configured to be executable by processing circuitry for causing the processing circuitry to:
generate embedding data based on sensor data;
generate key data, query data, and value data based on the embedding data;
perform a first matrix multiplication operation using the key data and the query data to produce a first result by at least generating a value in the first result using a row of the key data and a column of the query data;
perform a SoftMax operation on the first result to produce a second result; and
perform a second matrix multiplication operation using the second result and the value data.

10. The non-transitory computer-readable medium of claim 9, wherein to perform the first matrix multiplication operation, the instructions are executable by the processing circuitry for further causing the processing circuitry to:
supply the key data as a left matrix input to the first matrix multiplication operation;
supply the query data as a right matrix input to the first matrix multiplication operation; and
matrix multiply the left matrix input with the right matrix input.

11. The non-transitory computer-readable medium of claim 10, wherein to supply the query data as the right matrix input, the instructions are executable by the processing circuitry for further causing the processing circuitry to:
transpose-read the query data from memory; and
supply the query data in a transposed form to the right matrix input.

12. The non-transitory computer-readable medium of claim 9, wherein the instructions are executable by the processing circuitry for further causing the processing circuitry to transpose-write the second result to a memory, resulting in a transpose-written second result, and wherein to perform the second matrix multiplication operation, the instructions are executable by the processing circuitry for further causing the processing circuitry to:
supply the transpose-written second result as a left matrix input to the second matrix multiplication operation;
supply the value data as a right matrix input to the second matrix multiplication operation; and
matrix multiply the left matrix input with the right matrix input.

13. The non-transitory computer-readable medium of claim 9, wherein the instructions are executable by the processing circuitry for further causing the processing circuitry to output a third result based on an output of the second matrix multiplication operation.

14. The non-transitory computer-readable medium of claim 9, wherein to perform the SoftMax operation, the instructions are executable by the processing circuitry for further causing the processing circuitry to perform a height-wise SoftMax operation on the first result.

15. The non-transitory computer-readable medium of claim 9, the processing circuitry performs the first matrix multiplication operation, the SoftMax operation, and the second matrix multiplication operation within a context of an encoder within a vision transformer network.

16. A system comprising:
processing circuitry configured to execute a transformer network, wherein the transformer network includes an encoder, wherein the encoder includes one or more multi-headed attention blocks, and wherein to execute the transformer network, the processing circuitry is configured to at least, for each multi-headed attention block of the one or more multi-headed attention blocks:
generate embedding data based on sensor data
generate key data, query data, and value data based on the embedding data;
perform a first matrix multiplication operation using the key data and the query data to produce a first result by at least generating a value in the first result using a row of the key data and a column of the query data;
perform a SoftMax operation on the first result to produce a second result; and
perform a second matrix multiplication operation using the second result and the value data.

17. The system of claim 16, wherein to perform the first matrix multiplication operation, the processing circuitry is further configured to:
supply the key data as a left matrix input to the first matrix multiplication operation;
supply the query data as a right matrix input to the first matrix multiplication operation, wherein to supply the query data as the right matrix input, the processing circuitry is further configured to:
transpose-read the query data from memory; and
supply the query data in a transposed form to the right matrix input; and
matrix multiply the left matrix input with the right matrix input.

18. The system of claim 16, wherein the processing circuitry is further configured to transpose-write the second result to a memory, resulting in a transpose-written second result, and wherein to perform the second matrix multiplication operation, the processing circuitry is further configured to:
supply the transpose-written second result as a left matrix input to the second matrix multiplication operation;
supply the value data as a right matrix input to the second matrix multiplication operation; and
matrix multiply the left matrix input with the right matrix input.

19. The system of claim 16, wherein the processing circuitry is further configured to output a third result based on an output of the second matrix multiplication operation.

20. The system of claim 16, wherein to perform the SoftMax operation, the processing circuitry is further configured to perform a height-wise SoftMax operation on the first result.
